(19) United States
(12) Patent Application Publication
(10) Pub. No.: US 2012/0233497 A1
(43) Pub. Date: Sep. 13, 2012

(54) DATA STORAGE APPARATUS, CACHE CONTROL APPARATUS AND METHOD FOR CONTROLLING CACHE MEMORY

(75) Inventor: Takayuki MORI, Hachioji-shi (JP)

(73) Assignee: KABUSHIKI KAISHA TOSHIBA, Tokyo (JP)

(21) Appl. No.: 13/316,312

(22) Filed: Dec. 9, 2011

(30) Foreign Application Priority Data
Mar. 11, 2011 (JP) 2011-054379

(51) Int. Cl. G06F 11/07

(52) U.S. Cl. 714/6.11; 714/E11.023

(57) ABSTRACT

According to one embodiment, a cache control apparatus includes an error detecting and correcting module and a controller. The error detecting and correcting module is configured to detect errors in the data read from a cache memory and to correct the errors. The controller is configured to control the supply of power to the cache memory if the error detecting and correcting module is unable to correct errors and if the errors are hard errors.

### CROSS-REFERENCE TO RELATED APPLICATIONS

This application is based upon and claims the benefit of priority from prior Japanese Patent Application No. 2011-054379, filed Mar. 11, 2011, the entire contents of which are incorporated herein by reference.

### FIELD

Embodiments described herein relate generally to a cache control apparatus configured to control a cache memory, a method for controlling a cache memory, and a data storage apparatus.

### BACKGROUND

Hitherto, any data storage apparatus such as a hard disk drive (HDD) has, in addition to a main storage device (e.g., DRAM or disk), a cache memory configured to perform caching and a cache controller.

The cache controller is configured to access the cache memory in units of lines. Assume that the data read from a cache line contains errors that cannot be corrected in the error checking and correcting (ECC) process. Then, the cache controller writes the data again to the cache line in which the error have occurred. Note that the cache lines are units of data the cache memory stores.

The conventional cache controller writes data again if the data contains errors that cannot be corrected. When the data written again is read, errors may occur in the data. In this case, the cache controller determines that the hard errors have occurred. In some cases, the cache line is sealed off and inhibited from being used, because of the hard errors it contains. Consequently, the cache memory may be degraded in terms of its performance.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is a block diagram explaining the configuration of a cache controller according to an embodiment;

FIG. 2 is a block diagram explaining the major components of a hard disk drive that uses the cache controller according to the embodiment;

FIG. 3 is a block diagram explaining the major components of an SSD that uses the cache controller according to the embodiment; and

FIG. 4 is a flowchart explaining how the operation of the cache controller according to the embodiment.

### DETAILED DESCRIPTION

Various embodiments will be described hereinafter with reference to the accompanying drawings.

In general, according to one embodiment, a cache control apparatus includes an error detecting and correcting module and a controller. The error detecting and correcting module is configured to detect errors in the data read from a cache memory and to correct the errors. The controller is configured to control the supply of power to the cache memory if the error detecting and correcting module is unable to correct errors and if the errors are hard errors.

[Configuration of the Cache Controller]

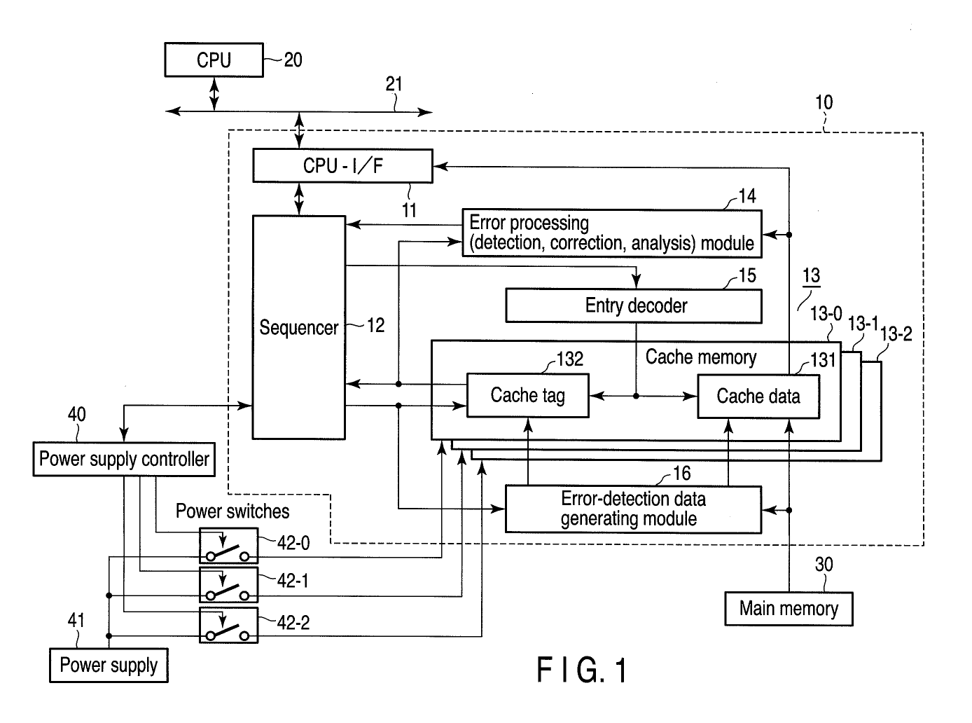

FIG. 1 is a block diagram showing the configuration of a cache controller 10 according to an embodiment.

As shown in FIG. 1, the cache controller 10 has an interface (CPU interface) 11, a sequencer 12, a cache memory group 13, an error processing module 14, an entry decoder 15, and an error-detection data generating module 16.

The interface 11 controls the transfer of data and commands to and from an external microprocessor (CPU) 20 through a bus 21. The CPU 20 is incorporated in a data storage apparatus, such as an HDD or a solid state drive (SSD) as will be described later, and controls the data transfer between the cache controller 10 and a host system.

The sequencer 12 is the main controller in the cache controller 10 and comprises, for example, hardware logic and a group of registers. The cache memory group 13 is composed of a plurality of cache memories, more precisely three cache memories 13-0 to 13-2 in this embodiment. Each cache memory is composed of a plurality of cache lines.

Each of cache memories 13-0 to 13-2 includes a cache data area 131 for holding cache data and a cache tag area 132 for holding a cache tag. The cache data area 131 is, for example, a static random access memory (RAM). The cache tag area 132 is, for example, a flip-flop group.

The error processing module 14 is configured to perform an error checking and correcting (ECC) process and an error analysis process. That is, the error processing module 14 has the function of detecting errors, if any, in the data read from the cache memory group 13, analyzing the cause of errors, and correcting the errors. The error processing module 14 performs the function of analyzing the cause of errors, determining whether the errors are soft errors or hard errors, as will be described later.

The entry decoder 15 decodes the address designated in response to a read command coming from the CPU 20. The error-detection data generating module 16 generates error-check data (ECC data) for use in detecting errors and adds this data to the cache data held in the cache memory group 13. The cache controller 10 further includes an interface (not shown) configured to transfer data to and from a main memory 30. The main memory 30 is, for example, a DRAM.

The cache controller 10 according to this embodiment is connected to a power supply control module including a power supply controller 40 and power switches 42-0 to 42-2. The power supply controller 40 controls the supply of power from a power supply 41 to cache memories 13-0 to 13-2 of the cache memory group 13, in accordance with the instructions coming from the sequencer 12. More precisely, the power supply controller 40 either supplies power to cache memories 13-0 to 13-2 through independent power-supply components (i.e., power switches 42-0 to 42-2), or interrupts the supply of power to cache memories 13-0 to 13-2.

[Data Storage Apparatus]

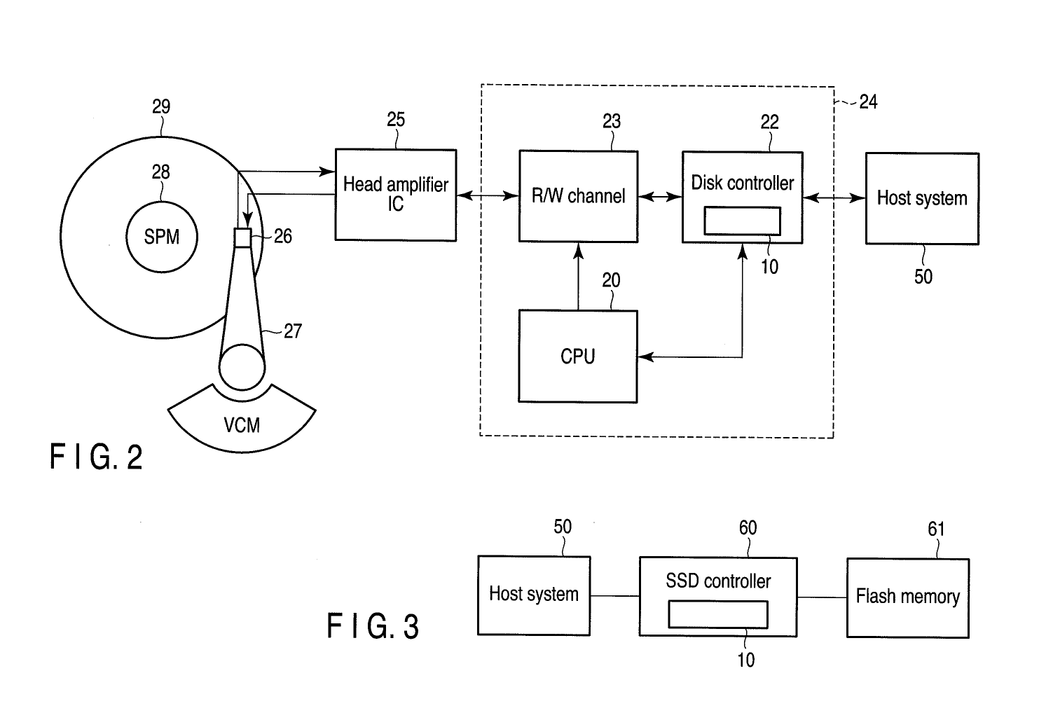

FIG. 2 is a block diagram explaining the major components of a hard disk drive (HDD).

The HDD has a disk controller (HDC) 22 that constitutes an interface with the host system (e.g., personal computer) 50. The cache controller 10 and power supply control module according to this embodiment can be used as a cache module for the disk controller 22.

As shown in FIG. 2, the HDD is composed mainly of a head-disk assembly (HDA), a head amplifier integrated circuit (head amplifier IC) 25, and a module 24 including the disk controller 22. The module 24 includes an R/W channel 23 and a CPU 20, in addition to disk controller 22.

The HDA has a disk 29, a spindle motor (SPM) 28, and an actuator 27 holding a head 26. The disk 29 is secured to the spindle motor 28 and rotated by the spindle motor 28. The actuator 27 is driven by a voice coil motor (VCM), moving the head 26 to a designated position over the disk 29. The head 26 has a write head element and a read head element. The write head element is configured to write data to the disk 29. The read head element is configured to read data from the disk 29.

The head amplifier IC 25 has a read amplifier configured to amplify the data signal read by the read head element and transmits the signal to the read/write (R/W) channel 23. The head amplifier IC 25 transmits, to the write head element, a write current corresponding to the data output from the R/W channel 23.

FIG. 3 is a block diagram showing the major components of an SSD.

The SSD has an interface with the hard disk drive and the host system 50, and an SSD controller 60 configured to control a flash memory 61, i.e., data storage medium. The cache controller 10 and power supply control module according to this embodiment can be used as cache module for the SSD controller 60.

[Operation of the Cache Controller]

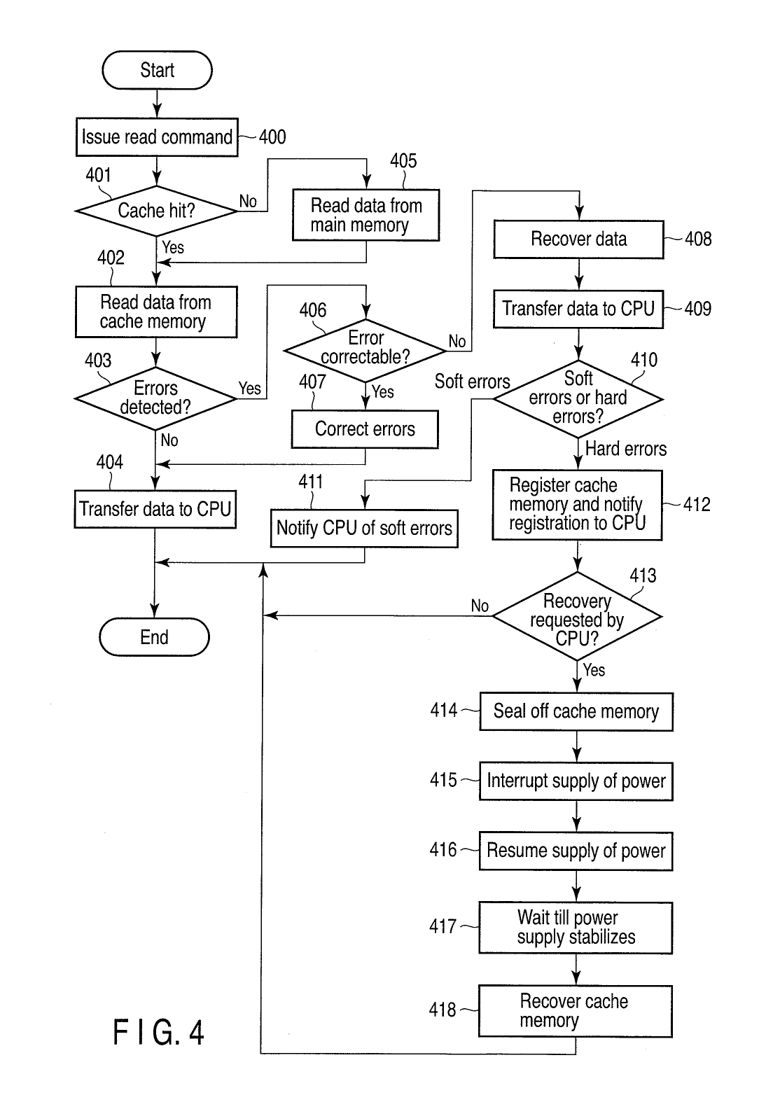

How the cache controller 10 operates will be explained with reference to the flowchart of FIG. 4.

First, in response to a read command (i.e., command for issuing a read command) coming from the CPU 20, the sequencer 12 starts operating (Block 400). That is, the sequencer 12 searches the cache tag area 132 for a cache tag, determining whether the cache memory group 13 holds the data associated with the cache tag (hit or miss) (Block 401).

If the cache memory group 13 holds the data (if hit), the sequencer 12 reads the data from the cache data area 131 (Block 402). If the cache memory group 13 holds the data (if miss), the sequencer 12 acquires the data, in units of lines, from the main memory 30 and saves the data in the cache memory group 13 (Block 405).

The sequencer 12 updates the data about the cache tag in the cache tag area 132 (i.e., address, access history, and validity of the cache data). The data acquired in units of lines includes the data associated with the cache tag and the other data already read. After saving the data from the main memory 30 to the cache memory group 13, the sequencer 12 reads the data associated with the cache tag, from the cache data area 131 (Block 402).

The error processing module 14 determines whether the data read from the cache data area 131 contains errors (Block 403). If no errors are detected from the data (NO in Block 403), the sequencer 12 transfers the data to be read as demanded, to the CPU 20 through the interface 11 (Block 404).

If errors are detected from the data read, the error processing module 14 determines whether the errors can be corrected by using the ECC data added to the data (Block 406). Note that the ECC data is error correction data encoded by a prescribed encoding system. If the errors can be corrected, the error processing module 14 corrects the errors (Block 407). The sequencer 12 transfer the data now free of errors, to the CPU 20 through the interface 11 (Block 404).

If the errors cannot be corrected (NO in Block 406), the error processing module 14 performs an existing data-recovery method, recovering the data (Block 408). For example, the sequencer 12 acquires again the cache line (i.e., line unit data containing the read request) in which the errors have occurred, from the main memory 30 in response to the notification received from the error processing module 14 and showing that the errors cannot be corrected. The sequencer 12 then transfers the data to be read as commanded, to the CPU 20 (Block 409).

The error processing module 14 analyzes the cause of the errors, determining whether the errors are soft errors or hard errors (Block 410). More precisely, the error processing module 14 performs an existing error analysis method, determining whether the errors are soft errors or hard errors. For example, the sequencer 12 writes the data read again from the main memory 30, to the cache data area 131 holding the cache line in which the errors have occurred. If errors different from or identical to an estimated value are made when the cache line is read, the error processing module 14 determines that the errors are hard errors. On the other hand, if errors identical to the estimated value are made or no errors are made at all, the error processing module 14 determines that the errors are soft errors.

If the error processing module 14 determines that the errors are soft errors in the error analysis, the sequencer 12 notifies this fact to the CPU 20, and terminates the process (Block 411). If the errors are soft errors, the CPU 20 performs a read/write operation in response to the notification coming from the sequencer 12 and can recover the data.

If the error processing module 14 determines that the errors are hard errors, the sequencer 12 registers the cache memory storing the data (i.e., cache memory 13-0 in this instance) in an internal register, as cache memory to undergo a power-down process (or to undergo the power supply control), and then notifies this registration to the CPU 20 (Block 412).

The cache controller 10 according to this embodiment terminates the process if the CPU 20 makes no requests for data recovery against hard errors (NO in Block 413). Assume that the CPU 20 determines that the data should undergo a recovery process against the hard errors (YES in Block 413), from the notification coming from the cache controller 10 and showing that the cache memory storing the data should undergo the power-down process. Then, the CPU 20 issues an invalidate request for the power-down process on the cache memory. The “recovery process” is a process of recovering the cache memory 13-0, where the hard errors have occurred.

On receiving the command from the CPU 20, the sequencer 12 seals off cache memory 13-0 (Block 414). That is, the sequencer 12 exempts cache 13-0 as device for storing the cache tag and cache data.

Next, the sequencer 12 instructs the power supply controller 40 to interrupt the supply of power to cache memory 13-0 (Block 415). So instructed, the power supply controller 40 interrupts the supply of power to cache memory 13-0.

Upon lapse of a prescribed time including the period in which the power supply stabilizes after the interruption of the supply of power, the power supply controller 40 resumes the supply of power to cache memory 13-0 (Block 416). Upon lapse of the period in which the power supply stabilizes, the power supply controller 40 informs the sequencer 12 that the power supply has stabilized. Then, the sequencer 12 determines that the hard errors have been eliminated, and performs a process of recovering the cache memory 13-0 (Block 418).

In this embodiment, the power supply control is performed, first interrupting the supply of power to, and then resuming the supply of power to, the cache memory in which hard errors are found to have occurred (e.g., cache memory 13-0). The hard errors can thereby be eliminated.

This embodiment is based on the assumption that hard errors are a memory-function problem resulting from, for example, a phenomenon called “single-event latch-up.” Hard errors of this type occur occurs if charged particles resulting from, for example, cosmic rays enter the cache controller 10, and a large current therefore flows in the cache memories, inevitably making a memory-function problem. The memory-function problem resulting from such hardware errors can be solved in all probability. This is why the power supply control that the power supply controller 40 performs can eliminate the hard errors in this embodiment.

If the hard errors have resulted from the destruction of the memory elements of any cache memory, the data in the cache memory can hardly be recovered. If hard errors occur even in any cache memory in which data has been recovered through the power supply control, the cache controller 10 determines that the hard errors result from the destruction of the memory elements. In this case, the cache controller 10 seals off the cache memory and inhibits the use of the cache memory (also informs the CPU 20 of this inhibition).

The cache controller 10 according to this embodiment can recover the data read from any cache memory even if the errors detected in the data are hard errors and cannot be corrected. The data, which should be read, can therefore be transferred to the CPU 20. Hence, the data is recovered during the caching, not interrupting the caching at all. This can suppress the performance degradation of any cache memory of the group 13.

In order to prevent hard errors, the power-down process (i.e., power-supply control process) is performed, eliminating the hard errors which are a memory-function problem resulting form, for example, a phenomenon called “single-event latch-up.” That is, positions where hard errors may occur in each cache memory can be decreased in numbers. This reduces the chance of sealing off the cache memory. As a result, the lifetime of each cache memory can be lengthened, and hard errors can be reduced at high efficiency.

In this embodiment, power is supplied to cache memories 13-0 to 13-2 through independent power-supply components (i.e., power switches 42-0 to 42-2). Therefore, the power-down process (i.e., power-supply control process) can be performed on only any cache memory that has hard errors. Hence, the caching can proceed in the other cache memories having no hard errors.

### (Modification)

As has been described, in the cache controller 10 according to this embodiment, the power supply control is performed on any cache memory that has hard errors, first interrupting the supply of power to, and then resuming the supply of power to, the cache memory. After the power supply control, the cache memory is recovered.

The cache controller 10 may be modified to test any cache memory fund to have hard errors after the supply of power is resumed, and the cache memory is recovered if the cache memory has no hard errors or stores many usable cache lines. In this modification, if no conditions for recovery are satisfied, the cache memory is sealed off again and the supply of power to the cache memory is interrupted. The performance of the cache memory is consequently degraded. Nonetheless, wasteful power consumption can be suppressed.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A cache control apparatus comprising:
an error detecting and correcting module configured to detect errors from data read from a cache memory and to attempt to correct the errors; and
a controller configured to control, if the error detecting and correcting module is unable to correct the errors and if the errors are hard errors, a power supply by
interrupting a supply of power to the cache memory, and
resuming the supply of power to the cache memory.

2. The cache control apparatus of claim 1, wherein the controller is configured to seal off the cache memory before interrupting a supply of power to the cache memory, and to recover the cache memory after resuming the supply of power to the cache memory.

3. The cache control apparatus of claim 1, further comprising a plurality of cache memories to which power is independently supplied,
wherein the controller is configured to control the power supply to any cache memory if the error detecting and correcting module is unable to correct the errors and if the errors are hard errors.

4. The cache control apparatus of claim 1, wherein the controller is configured to perform the power supply control function in order to eliminate hard errors resulting from a single-event latch-up phenomenon.

5. The cache control apparatus of claim 1, further comprising a module configured to perform a data recovering process if the error detecting and correcting module is unable to correct the errors.

6. The cache control apparatus of claim 1, wherein the controller is configured to determine whether the cache memory stores data designated by a read command coming from a microprocessor, and to notify a decision to the microprocessor if the error detecting and correcting module is unable to correct the errors and of the errors are soft errors.

7. The cache control apparatus of claim 1, wherein the controller is configured to recover the cache memory upon lapse of a stabilizing period after controlling the supply of power to the cache memory.

8. The cache control apparatus of claim 1, wherein the controller is configured to register the cache memory as cache memory to undergo power supply control, if the error detecting and correcting module is unable to correct the errors and if the errors are hard errors.

9. The cache control apparatus of claim 8, wherein the controller is configured to notify a microprocessor that the cache memory has been registered as cache memory to undergo power supply control, and to control the power supply in response to a command coming from the microprocessor.

10. A method for controlling a cache memory, the method comprising:
detecting errors from data read from the cache memory;
correcting the errors; and
controlling, if the errors cannot be corrected and if the errors are hard errors, a power supply by
interrupting a supply of power to the cache memory, and
resuming the supply of power to the cache memory.

11. A data storage apparatus comprising:
a storage medium configured to store data; and
a cache controller configured to read, from a cache memory, data designated by a read command made to the storage medium;
wherein the cache controller is configured to detect errors from the data read from the cache memory, to correct the errors, and to control, if the errors are unable to be corrected and are hard errors, a power supply by interrupting a supply of power to the cache memory and then resuming the supply of power to the cache memory.
